(19) United States
(12) Patent Application Publication
(10) Pub. No.: US 2014/0094163 A1
(43) Pub. Date: Apr. 3, 2014

(54) Method and Apparatus for Pre-Loading Information Over a Communication Network

(71) Applicant: Rockstar Consortium US LP, Plano, TX (US)

(72) Inventors: Scott Widdowson, Ottawa (CA); Keith Edwards, Hutton (GB)

(73) Assignee: Rockstar Consortium US LP, Plano, TX (US)

(21) Appl. No.: 14/093,477

(22) Filed: Dec. 1, 2013

Related U.S. Application Data
(63) Continuation of application No. PCT/CA11/50398, filed on Jun. 29, 2011.

(51) Int. Cl. H04W 28/06

(52) U.S. Cl. CPC H04W 28/06
USPC 455/422.1

(57) ABSTRACT

Data is downloaded to a wireless device before needed by the user. The data may be downloaded before needed, for example while connected to a high-bandwidth network, slowly over a bandwidth constrained network, during a time when the network is not busy, or when the network operator has reduced tariff for data usage. The data may be downloaded contiguously or may updated over a period of time. At a later point in time, the previously downloaded data is used to provide information to the user without requiring contemporaneous information transmission on the wireless network.

### CROSS-REFERENCE TO RELATED APPLICATIONS

This application is a continuation of International Application PCT/CA2011/050398, filed Jun. 29, 2013, the content of which is hereby incorporated herein by reference.

### TECHNICAL FIELD

The present invention relates to communication networks and, more particularly, to a method and apparatus for pre-loading information over a communication network.

### BACKGROUND

Data communication networks may include various computers, servers, nodes, routers, switches, bridges, hubs, proxies, and other network devices coupled together and configured to pass data to one another. These devices will be referred to herein as “network elements.” Data is communicated through the data communication network by passing protocol data units, such as data frames, packets, cells, or segments, between the network elements by utilizing one or more communication links. A particular protocol data unit may be handled by multiple network elements and cross multiple communication links as it travels between its source and its destination over the network.

Cellular wireless networks were initially developed and deployed to carry voice traffic. As portable handheld electronic devices become increasingly sophisticated, users have demanded that these networks also carry data traffic. Thus, wireless networks have been developed or adapted to provide data access, for example to provide email service and to allow Internet access. However, often the processing capabilities of the devices connected to the wireless network enable the devices to use much more data than is able to be transmitted on the wireless network. Accordingly, even with high bandwidth networks such as fourth generation cellular networks, the ability of the network to provide data to the wireless device detracts from user quality of experience. Likewise, the increased signaling and data traffic related to device and application usage can pose a significant challenge to network operators.

### SUMMARY OF THE INVENTION

The following Summary and the Abstract set forth at the end of this application are provided herein to introduce some concepts discussed in the Detailed Description below. The Summary and Abstract sections are not comprehensive and are not intended to delineate the scope of protectable subject matter which is set forth by the claims presented below.

Data is downloaded to a wireless device before needed by the user. The data may be downloaded before needed, for example while connected to a high-bandwidth network, slowly over a bandwidth constrained network, during a time when the network is not busy, or when the network operator has reduced tariffs for data usage. The data may be downloaded contiguously or may updated over a period of time. At a later point in time, the previously downloaded data is used to provide information to the user without requiring contemporaneous transmission of the information on the wireless network.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a reference network;

FIG. 2 is a functional block diagram of the reference network of FIG. 1 in greater detail showing several possible flows of information on the network according to an embodiment of the invention; and

FIGS. 3-5 are flow charts showing processes that may be implemented according to embodiments of the invention.

### DETAILED DESCRIPTION

Handheld electronic devices and other wireless devices are increasingly capable of playing high resolution video, graphics, three dimensional animations, running applications, providing access to virtual environments, and otherwise providing immersive content to users. Many of these applications require high bandwidth access to a wireless network. MPEG-4, for example, allows video to be transmitted using anywhere between a few kilobytes of bandwidth to up to 10 Mb of bandwidth. Larger bandwidth video often is deemed desirable, since it provides a higher quality picture and, hence, better quality of experience to the end user. As an example, when a user moves from one region to another region, the user may desire to have maps, information on tourist attractions, restaurants, and hotels, and other types of information downloaded to their phone. This may take considerable bandwidth which may not be available when the user attempts to access the information by connecting to the wireless network.

According to an embodiment, information of this sort or other information may be downloaded to the user's phone before required by the user and optionally without the user's input or knowledge. For example, analytics can be used to determine if the user is going out of a region and new information may be downloaded to the user's device so that the information is available when the user arrives at the new destination. Once the user arrives at the destination, the information can be presented to the user using a low bandwidth trigger. The trigger may be transmitted on a control channel or may be implemented using a small data transfer over the traffic channel. For example, the trigger may be a short code implemented using a few bytes of data traffic. Upon receipt of the trigger, the information that was previously downloaded to the user's phone may be used by the phone to provide high quality user experience. Other types of information may be downloaded in a similar manner and utilized by the device upon obtaining a trigger.

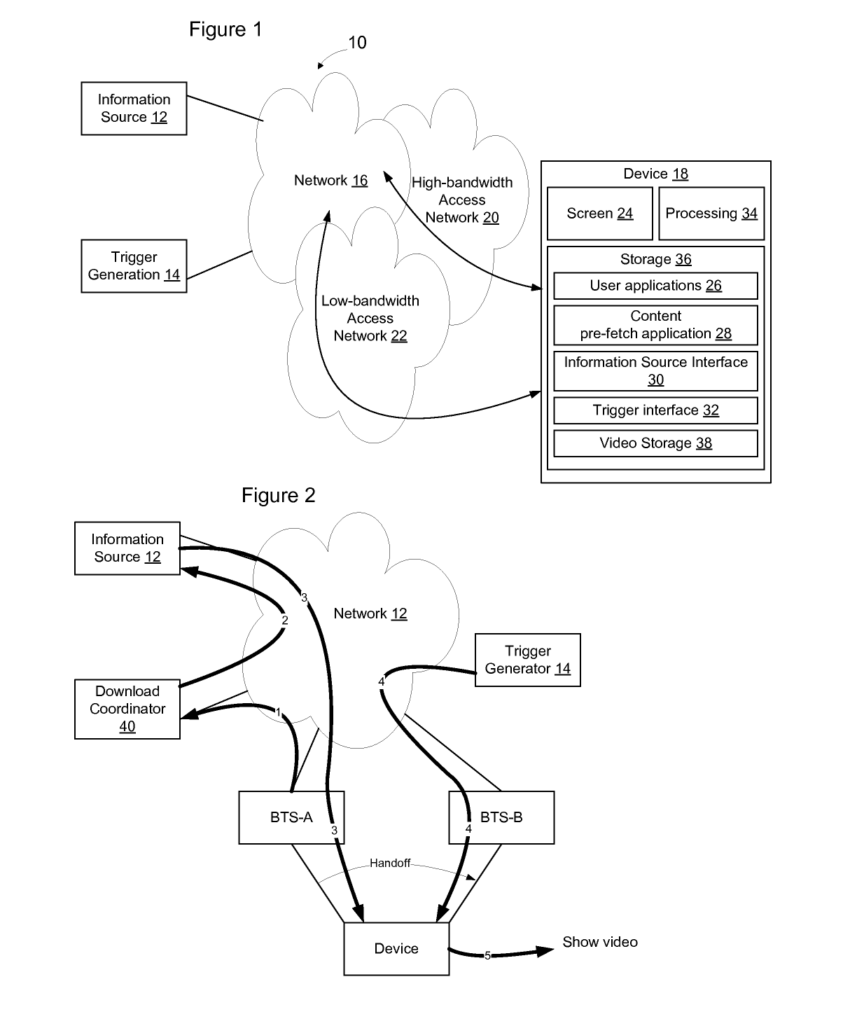

FIG. 1 shows an example network 10 in which an information source 12 and trigger generator 14 are connected to a network 16. Network 16 may be, for example, the Internet. Information source 12 and trigger generator 14 may be implemented using servers connected to the network and may be separate devices or implemented together depending on the implementation. The information source and trigger generator may be within the network, or external to the network. Use of a trigger generator allows the operator or a third party application to send a trigger signal on the network to the device to control when data stored on the device is used to display information to the user. Alternatively, the trigger may be obtained by the device without transmission of a signal on the network, when the device perceives an event that has been predefined to cause information to be displayed. For example, the trigger may be associated with access by the user to a separate function or other data on the device. Thus, the trigger may be indirectly activated by the user when the user uses the device to obtain access to data or functionality provided by another application running on the device.

Devices 18 connect to network 16 to obtain content available via network 16. For example, where network 16 is the Internet, multiple web sites available via the network provide data and services which may be accessed using mobile devices. The devices obtain access to network 16 using one or more access networks. Some of the access networks are high bandwidth access networks 20 while other access networks may have considerably less available bandwidth (low-bandwidth access network 22). Several example access networks 20 include networks implemented using WiFi which is by one of the IEEE 802.11 protocols, WiMax which is specified by IEEE 802.16, or cellular technology such as Long Term Evolution (LTE), High Speed Packet Access (HSPA), Enhanced Data rates for GSM Evolution (EDGE) and Evolved EDGE, 3rd generation Partnership Project 2 (3GPP2) CDMA and its extensions, including cdmaOne (IS-95), CDMA2000 and Ultra Mobile Broadband (UMB). Other wireless protocols exist as well and are likely to continue to be developed over time. The invention is not limited to an implementation that utilizes one of the particular listed access networks.

There are many reasons why transmission of data in real time may constrain the ability of the device 18 to provide data to the user. For example, if the device is connected to a low-bandwidth network 22, the designed bandwidth of the network may be insufficient to provide the user with information available on network 16. Even if the designed capabilities of the network are sufficient to meet the data needs of the device 18, the channel conditions may be such that only a limited amount of data may be able to be transmitted for a period of time.

According to an embodiment, information to be shown on device 18 is downloaded from information source 12 over network 16 to device 18 when the device is connected to high-bandwidth access network, when channel conditions are favorable, slowly over time e.g. when connected to a low bandwidth network, or during a low usage period or a low tariff period. The information is downloaded ahead-of-time so that it is available and stored on device 18. Trigger generator 14 generates and transmits a trigger to the device on the network after the information has been downloaded and stored. This trigger, when received by the device 18, causes the information that was previously stored on the device to be used by the device to provide audio, high definition video, or other formatted information such as a document, a game, a user application, picture, advertisement, or other information that would not be able to be otherwise provided to the user using contemporaneous transmission of data on the wireless network. By proactively downloading the information in advance, it is possible to provide a more rich experience to the end user while the device is connected to an access network with insufficient bandwidth or capacity to stream the information in real-time.

Device 18 may be any type of wireless device, such as a laptop computer, e-reader, or portable handheld electronic device. Hand-held electronic devices may be used by a viewer to receive information via networks 20, 22, and display the information on a screen 24. Optionally, the screen may be touch-sensitive to also act as an input to the device 18. Where the screen is touch-sensitive, icons corresponding to user applications 26 are generated and appear on the touch-sensitive screen. When a user touches the touch-sensitive screen on an icon, the application corresponding to the icon is launched to cause the hand-held electronic device to implement the functionality associated with the application. Hundreds of thousands of applications have been developed for mobile platforms such as the Android operating system, Symbian (TM Nokia), Windows (TM Microsoft), BlackBerry OS (TM RIM) and iOS (TM Apple, Inc.) which is used as the operating system for mobile devices from Apple, such as the iPhone, iPad, and iTouch.

In contemporary devices, many user applications, such as a music or video storage applications, enable the user to cause content to be stored on the device 18 and, when instructed by the user, will cause the content to be played on the device 18. According to an embodiment, content prefetch application 28 runs in the background of the device without an icon or other user interface and, hence, is not directly able to be accessed by the user. Thus, the content that is downloaded to the device may not be previously known to the user and is not directly controlled by the user, such that the user does not initiate the download and does not directly control what content is downloaded to the device. The content prefetch application, in one embodiment, includes an information interface 30 to enable the device to interact with information source 12, as well as a trigger interface 32 designed to receive notifications via the network and cause the information interface to either download data from the information source via the network or to display data on the screen 24 of device 18. Data is stored by the device in storage 38. Example content could include audio, video, documents, leaflets, magazines, books, applications, games, and information to be used by an application, such as maps, information on tourist attractions, hotels, airports, airline schedules. The storage 38 may be implemented using the same physical memory as is used to store other data on the device 18, or may be implemented using another storage medium.

The trigger interface can receive triggers from trigger generator 14 or from other sources on the network. For example, the trigger interface 32 may receive a notification that information is available to be downloaded, may receive a notification that information is to be displayed, or may receive another type of notification. Likewise, the trigger interface can detect other operating conditions of the device such as network connectivity and use changes in the detected operating conditions as trigger events. The trigger interface can also receive triggers from other content, for example when the device is being used to access web pages on the Internet. In response to receipt of a trigger from the network or elsewhere, the trigger interface 32 instructs the information interface to retrieve information from the information source, display information on the device, or otherwise manipulate the information to make the information available to the user.

Device 18 has a processor 34 as well as memory 36, which may be implemented using internal or external memory, e.g. using a SanDisk™ memory card. In operation, applications and data will be stored in memory 36 and loaded into processor 34, to enable the processor 34 to implement methods which dictate how the device will operate and, hence, how the user is able to use the device. Several example methods of operating the device in accordance with embodiments of the invention are set forth below in connection with FIGS. 2-5.

FIG. 2 graphically illustrates an example of how information may be pre-loaded onto a wireless device to allow content to be provided to the user using a small trigger signal without requiring the content to be contemporaneously downloaded. Thus, content may be provided to the user even if bandwidth is not available at the time of the event, or if it is determined that the bandwidth of the wireless channel is not to be used at the same time as the information is to be provided. As shown in FIG. 2, The device is initially connected to Base Transceiver Station (BTS) A which is part of a high bandwidth Long Term Evolution (LTE) fourth generation (4G) wireless cellular network. Because of movement of the device within the network, a handoff from BTS-A in the LTE network to BTS-B in a low bandwidth network is determined to be imminent. Accordingly, BTS-A notifies a download coordinator 40 (arrow 1) which contacts information source (arrow 2) to instruct Information Source 12 to push content to device (arrow 3) before responsibility for device is transferred during the handoff. By causing the data to be downloaded to the device prior to handoff, the device may be loaded with content while connected to the high bandwidth network. Subsequently, after the handoff occurs, the trigger generator 14 may send a trigger (arrow 4) which will be received by trigger interface 32 and deciphered. Trigger interface will interact with content pre-fetch application or information interface to cause data identified in the trigger to be read out of storage 38 and displayed on the screen 24 of device 18 (arrow 5). The trigger only requires a low bandwidth link, and can either be sent over the control channel or on a traffic channel of the wireless network.

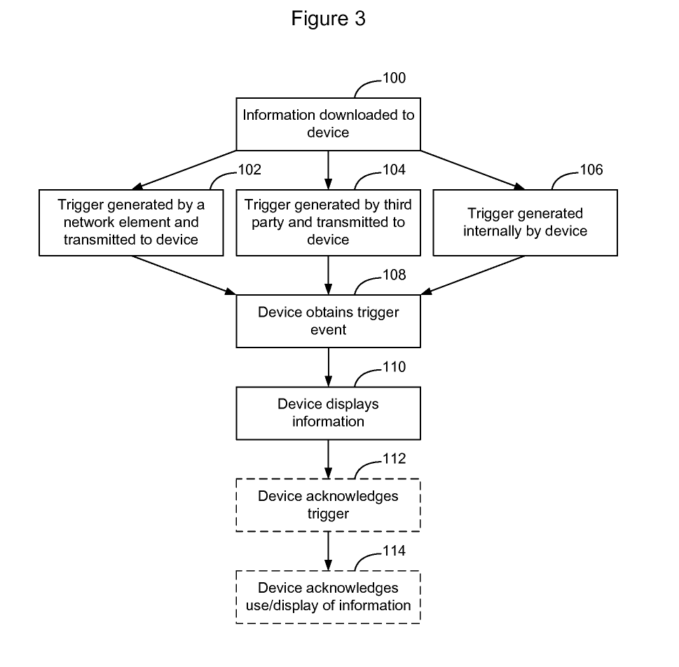

FIG. 3 shows an example process that may be implemented according to an embodiment. As shown in FIG. 3, information is downloaded to the device (100). Information may be downloaded at a scheduled time, for example during a period of low use on the wireless network, during a period when the network operator has reduced tariffs, while the device is connected to a network with favorable channel conditions or when the device is connected to a wireless network with high bandwidth capabilities, or in other situations when it is determined that the information is required to be present on the device at some future time, e.g. through analytics.

In one embodiment, when the wireless device is connected to a high-bandwidth network, the content pre-fetch application accesses the information source or download coordinator to request data to be transmitted to the device. In another embodiment, as described in connection with FIG. 2, a network element may contact the download coordinator or information source to notify these entities that the device is connected to the wireless network and available to receive data. Other embodiments may determine when to download information to the device using other methods as well. However, since the content pre-fetch application 28 is not a user operated application, the timing of delivery of the content is not dictated by the user and is not done under the control of the user, other than through pre-populated user configuration settings. Likewise, activation of the information is not under the control of the user as use of the information will occur automatically when the device obtains a trigger. Hence, the user does not control the timing of the download of the content, does not control what content is downloaded, and does not directly control when the content will be used by the device. In this regard, the content download is dissimilar from other types of content storage. For example, when a user synchronizes a wireless device with a computer, the user controls when the content to be synchronized is downloaded and also selects what content, e.g. songs, videos, pictures, will be stored on the portable handheld wireless device. The information that is downloaded in implementations of this invention, by contrast, is not controlled by the user and not able to be controlled by the user. Note, that the user may be involved in the initial subscription to the Information Source, or at least may be able to opt out, or set the frequency of trigger events. For example, the user may be provided with a portal or interface to specify that trigger events should only happen on weekends, evenings, or to otherwise specify the timing and frequency of trigger events. Thus, the user may indirectly be involved in setting up how the content download is implemented on the device, but the user is not involved with selecting the content that is downloaded using the content download features described herein.

At a later point in time, a trigger will cause the previously downloaded content to be displayed to the user. The trigger event may be generated by a network element and transmitted to the device on the network (102). For example, when the user moves from one network to another, one of the BTSs associated with the handoff may generate and transmit a trigger to the device to cause the device to play the video. An example of this may be where the user is roaming to a new area. In this event, the BTS or other device associated with one of the networks may generate a trigger to cause the device to show a video about how to turn off data usage so that the user does not incur substantial data charges in the roaming network. Movement between networks may occur in many ways. For example, different networks may be operated by different network operators, which may charge differently for data usage. Likewise, the networks may be implemented using the same or different air interface standards. For example, the network transition may be from UMTS to UMTS, UMTS-GSM, LTE-GSM, GSM-WiFi, etc.

Alternatively, the trigger event may be generated by a third party and transmitted to the device (104). An example of this may be where an advertiser would like to provide advertising to a group of mobile device users. At the designated time, the advertiser may generate and transmit a trigger to cause a previously downloaded video advertisement to be displayed on the device.

Still alternatively, the trigger may be generated internally by the device, e.g. in connection with circumstances or actions undertaken by the user (106). For example, if the user goes to the airport and boards a plane, content associated with the destination may be downloaded for the user before the user turns off the device. When the user later turns on the device, the device may sense the new location and display video about the airport where the user has landed.

Regardless of the trigger event, when the device receives and detects the trigger (108) it will display the information (110). Since the information such as a video has previously been downloaded to the device, display of the high quality video, for example, may be implemented without requiring significant contemporaneous bandwidth to thereby provide high quality video regardless of the capabilities of the network at the time.

Optionally, the device may acknowledge the trigger (112) by transmitting a response message to the trigger generator 14. Likewise, the device may acknowledge use or presentation of the previously downloaded information, whether presentation of the information was interrupted, and whether the user interacted with the information, e.g. by electing to initiate contact with a third party in connection with the information (114). Providing this feedback enables the effectiveness of the availability of the information to be determined, which may provide additional revenue opportunities in connection with advertising.

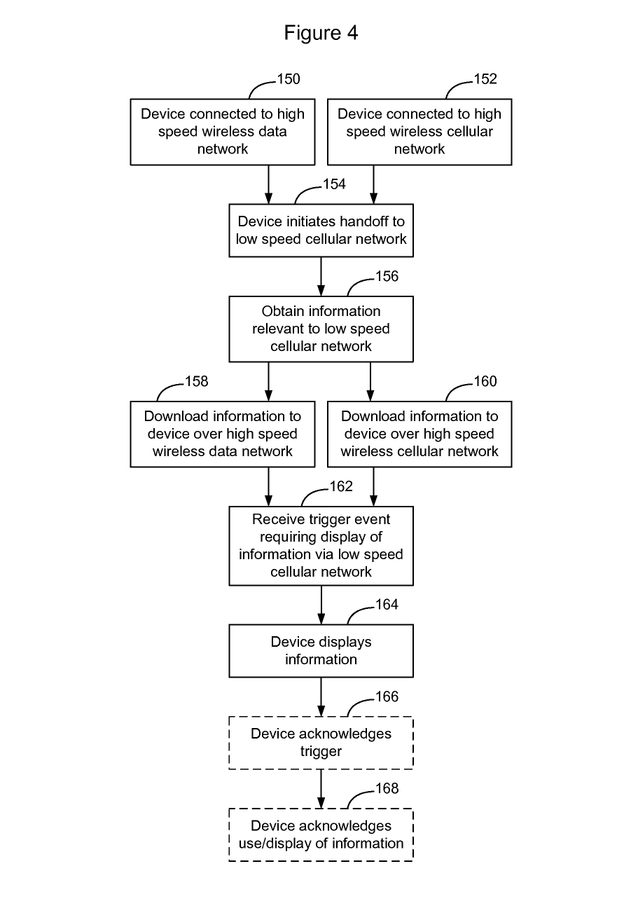

FIG. 4 shows another example of how content may be utilized in connection with a handoff between a high bandwidth wireless network and a low bandwidth wireless network. As shown in FIG. 4, initially the device is connected to a high speed wireless data network (150) or high bandwidth wireless cellular network (152). The device will then initiate handoff to a low bandwidth cellular network (154).

When the device initiates handoff to the low bandwidth network, information about the low bandwidth cellular network will be obtained (156) and, prior to handoff, the download coordinator will cause information to be downloaded to the device via the high bandwidth wireless data network (158) or via the high bandwidth cellular network (160). Thus, in this example, initiation of handoff to an environment with less data capabilities causes the content pre-fetch application or the network elements involved in the handoff to cause information source 12 to be polled to determine if any relevant information should be downloaded to the device before the device transitions to the low bandwidth environment. The high bandwidth facilities are then used to the extent possible to download content that may later be needed by the device to enable the device to provide high bandwidth information while connected to the lower bandwidth network.

After the device transitions to the low bandwidth wireless network, the device will receive a trigger event on the low bandwidth network requiring display of information (162). The trigger event will be received by the trigger interface and cause the content pre-fetch application to retrieve previously downloaded video to be displayed from the device's memory. This video will then be displayed on the screen of the device (164). Optionally, as noted above in connection with FIG. 3, the device may also acknowledge receipt of the trigger (166) and/or use or display of the information (168) as well as any interaction between the user and the content.

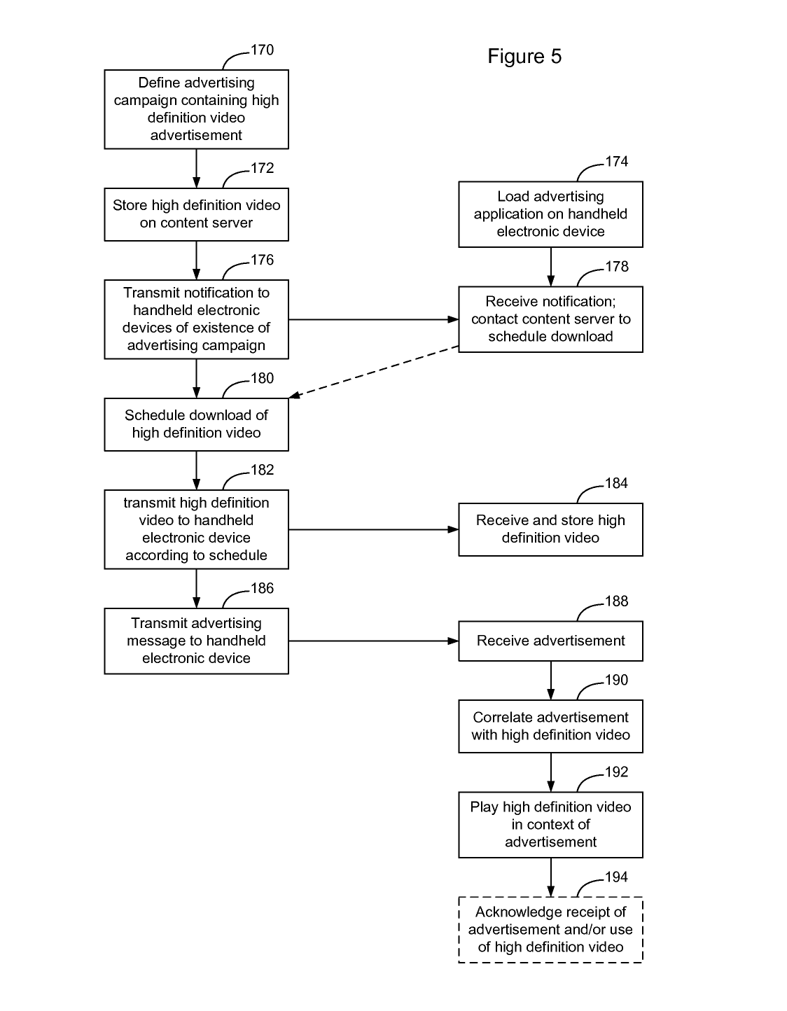

FIG. 5 shows an example of how an embodiment may be used in connection with advertising. As shown in FIG. 5, an advertiser will define an advertising campaign containing a high definition video advertisement (170). The high definition video will be stored on a content server or other server on a network such as the Internet (172). Coincidentally, an advertising application will be loaded onto the handheld electronic devices (174). The advertising application may be an implementation of the content pre-fetch application described above in connection with FIG. 1.

Once the content is ready to be downloaded to the devices, a notification will be transmitted to the devices of the existence of the advertising campaign (176). When the device receives the notification (178) it will contact the content server containing the high definition video advertisement to schedule the download of the video (180). Scheduling may incorporate timing as well as connectivity. For example, it may be cheaper to download high definition video to the device during quiet network periods or low tariff periods, such as late at night when the wireless network is less used. Likewise, the scheduling may require the device to be connected to a high bandwidth network or to wait for favorable channel conditions before commencing data download, so that the content is not scheduled to be downloaded when only a bandwidth constrained connection is available. Likewise, the download may be scheduled to occur when the user is not using the device for other activities, or may be scheduled to occur when the battery is being charged so that the data download does not drain power from the wireless device.

At the scheduled time (or scheduled location) the high definition video is transmitted to the handheld electronic device (182). The device will receive and store the high definition video (184) and optionally may acknowledge receipt of the video.

When the advertiser elects to cause the advertisement to be displayed, the advertiser will transmit an advertising message to the handheld electronic device (186). For example, the user may be accessing a web-page on the Internet and encounter a banner advertisement on a web-page. If the banner advertisement is associated with the advertisement that was previously downloaded, the high definition video may be replayed in the banner advertisement to provide enhanced content to the user that would otherwise not be available on the web page. An example of this may be a movie preview, product demonstration, or other type of advertisement.

When the device receives the advertisement notification (188) it will correlate the advertisement with the high definition video (190) and play the high definition video in the context of the advertisement (192). Optionally, the device may acknowledge receipt of the advertisement and/or use of the high definition video in connection with the advertisement (194).

The functions described above may be implemented as a set of program instructions that are stored in a computer readable memory and executed on one or more processors on the computer platform. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a non-transitory computer readable medium which includes all computer readable media, including but not limited to register memory, processor cache, RAM, and other forms of physical memory that may temporarily or permanently store information. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense.

What is claimed is:

1. A non-transitory tangible computer readable storage medium having stored thereon a computer program product for pre-loading content to a wireless electronic device, the computer program product comprising a set of instructions which, when executed by the wireless electronic device, cause the wireless electronic device to perform a method comprising the steps of:
automatically downloading information to be presented to a user of the wireless electronic device, via a first wireless network, without receiving direct instructions from the user to initiate downloading;
storing the information on the wireless electronic device;
obtaining a trigger signal, and
in response to the trigger signal, accessing the stored information and using the stored information to provide a presentation via a presentation interface on the wireless electronic device to the user.

2. The computer program product of claim 1, wherein the trigger signal is transmitted over the first wireless network.

3. The computer program product of claim 2, wherein the first wireless network is selected from a group including 3GPP, 3GPP2 and IEEE wireless standards.

4. The computer program product of claim 1, wherein the trigger signal is transmitted over a second wireless network.

5. The computer program product of claim 4, wherein the first wireless network is selected from a group including CDMA, LTE, WiMAX, GSM, UMTS and WiFi.

6. The computer program product of claim 1, wherein the trigger signal is not under the control of the user.

7. The computer program product of claim 1, wherein the information is not selected by the user and is not under the control of the user.

8. The computer program product of claim 1, wherein the trigger signal is initiated by a base transceiver station in the first wireless network.

9. The computer program product of claim 1, wherein the trigger signal data is smaller than the data required to download the information.

10. The computer program product of claim 1, wherein the trigger signal is generated by the device upon occurrence of an event.

11. A method of providing content to a user, the method comprising the steps of:
downloading information, by a wireless device via a wireless network, without directly receiving instructions from the user to initiate downloading of the information;
subsequently using the information to initiate a presentation to the user without contemporaneous transmission of the information on the wireless network and without receiving instructions from the user to initiate the presentation.

12. The method of claim 11, wherein the information is advertising.

13. The method of claim 11, wherein the information is provided to an application resident on the wireless device.

14. The method of claim 11, further comprising the step of obtaining a trigger prior to the step of using the information.

15. The method of claim 11, wherein the trigger is received via a wireless network.

16. The method of claim 11, wherein the trigger is associated with movement of the wireless device.

17. The method of claim 11, wherein the step of downloading information is implemented when the wireless device is connected to a wireless network with favorable channel conditions.

18. The method of claim 11, wherein the wireless network is a high bandwidth wireless network and wherein the step of downloading information is implemented when the wireless device is connected to the high bandwidth wireless network.

19. The method of claim 11, wherein the step of downloading is implemented during a period when an operator of the network has lower tariff rates.

20. The method of claim 11, wherein the step of downloading is implemented during a period of low usage of the wireless network.
